(19) United States
(12) Patent Application Publication
(10) Pub. No.: US 2023/0126672 A1
(43) Pub. Date: Apr. 27, 2023

(54) SYSTEMS AND METHODS FOR MIXED PRECISION MACHINE LEARNING WITH FULLY HOMOMORPHIC ENCRYPTION

(71) Applicant: JPMORGAN CHASE BANK, N.A., New York, NY (US)

(72) Inventors: Sanket KAMTHE, London (GB); Sean MORAN, Putney (GB); Jacob MENDEL, Givat Brenner (IL)

(21) Appl. No.: 17/511,895

(22) Filed: Oct. 27, 2021

(51) Int. Cl. H04L 9/00; H03M 7/24; G06N 20/00

(52) U.S. Cl. CPC H04L 9/008; H03M 7/24; G06N 20/00

(57) ABSTRACT

Systems and methods for mixed precision machine learning with fully homomorphic encryption are disclosed. A method may include receiving data in a mixed precision format from a program or an application executed by the client electronic device; converting the data from the mixed precision format to an integer format; encrypting the data in the integer format using a fully homomorphic data encryption scheme; communicating the encrypted data in the integer format to a host electronic device, wherein the host electronic device is configured to process the encrypted data in the integer format and provide an encrypted result in the integer format to the client electronic device; decrypting the encrypted result in the integer format using the fully homomorphic data encryption scheme; converting the decrypted result in the integer format to the mixed precision format; and outputting the result in the mixed precision format to the program or the application.

### BACKGROUND OF THE INVENTION

### 1. Field of the Invention

Embodiments relate generally to systems and methods for mixed precision machine learning with fully homomorphic encryption.

### 2. Description of the Related Art

Homomorphic encryption is becoming increasingly popular for machine learning applications. Rather than having a third-party decrypt encrypted data provided by a sender and risk data exposure, homomorphic encryption allows data to be manipulated in its encrypted state. The encrypted results are returned, and can be decrypted by the sender of the data. Homomorphic encryption, however, is computationally expensive and slow, thereby limiting its applicability to powerful computing systems.

### SUMMARY OF THE INVENTION

Systems and methods for mixed precision machine learning with fully homomorphic encryption are disclosed. According to one embodiment, a method for mixed precision machine learning with fully homomorphic encryption may include: (1) receiving, by a client rescaling computer program executed by a client electronic device, data in a mixed precision format from a program or an application executed by the client electronic device; (2) converting, by the client rescaling computer program, the data from the mixed precision format to an integer format; (3) encrypting, by a client encryption computer program executed by the client electronic device, the data in the integer format using a fully homomorphic data encryption scheme; (4) communicating, by the client electronic device, the encrypted data in the integer format to a host electronic device, wherein the host electronic device may be configured to process the encrypted data in the integer format and provide an encrypted result in the integer format to the client electronic device; (5) decrypting, by the client encryption computer program, the encrypted result in the integer format using the fully homomorphic data encryption scheme; (6) converting, by the client rescaling computer program, the decrypted result in the integer format to the mixed precision format; and (7) outputting, by the client rescaling computer program, the result in the mixed precision format to the program or the application.

In one embodiment, the mixed precision format may be a floating-point format. The integer format may be an INT8 format.

In one embodiment, the host electronic device may be configured to train a machine learning engine using the encrypted data in the integer format.

In one embodiment, the host electronic device may be configured to provide a machine learning engine with the encrypted data in the integer format as an input, and the encrypted result comprises an output of the machine learning engine.

According to another embodiment, an electronic device may include a memory storing a client rescaling computer program and a client encryption computer program and a computer processor. When executed by the computer processor, the client rescaling computer program or the client encryption computer program cause the computer processor to: receive data in a mixed precision format from a program or an application executed by the client electronic device; convert the data from the mixed precision format to an integer format; encrypt the data in the integer format using a fully homomorphic data encryption scheme; communicate the encrypted data in the integer format to a host electronic device, wherein the host electronic device may be configured to process the encrypted data in the integer format and provide an encrypted result in the integer format to the client electronic device; decrypt the encrypted result in the integer format using the fully homomorphic data encryption scheme; convert the decrypted result in the integer format to the mixed precision format; and output the result in the mixed precision format to the program or the application.

In one embodiment, the mixed precision format may be a floating-point format. The integer format may an INT8 format.

In one embodiment, the host electronic device may be configured to train a machine learning engine using the encrypted data in the integer format.

In one embodiment, the host electronic device may be configured to provide a machine learning engine with the encrypted data in the integer format as an input, and the encrypted result comprises an output of the machine learning engine.

According to another embodiment, a system may include a client electronic device executing a client rescaling computer program that receives data in a mixed precision format from a program or an application executed by the client electronic device and converts the data from the mixed precision format to an integer format, and a client encryption computer program that encrypts the data in the integer format using a fully homomorphic data encryption scheme and communicates the encrypted data in the integer format to a host electronic device; and a host electronic device that processes the encrypted data in the integer format and provides an encrypted result in the integer format to the client electronic device. The client encryption computer program decrypts the encrypted result in the integer format using the fully homomorphic data encryption scheme, and the client rescaling computer program convert the decrypted result in the integer format to the mixed precision format and outputs the result in the mixed precision format to the program or the application.

In one embodiment, the mixed precision format may be a floating-point format. The integer format may be an INT8 format.

In one embodiment, the host electronic device comprises a machine learning engine trained using the encrypted data in the integer format.

In one embodiment, the host electronic device comprises a machine learning engine, and the host electronic device provides the encrypted data in the integer format as an input to the machine learning engine, and the encrypted result comprises an output of the machine learning engine.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a depicts a system for mixed precision machine learning with fully homomorphic encryption according to an embodiment;

FIG. 2 depicts a method for mixed precision machine learning with fully homomorphic encryption according to an embodiment.

### DETAILED DESCRIPTION OF PREFERRED EMBODIMENTS

Embodiments relate generally to systems and methods for mixed precision machine learning with fully homomorphic encryption, such as with floating point numbers.

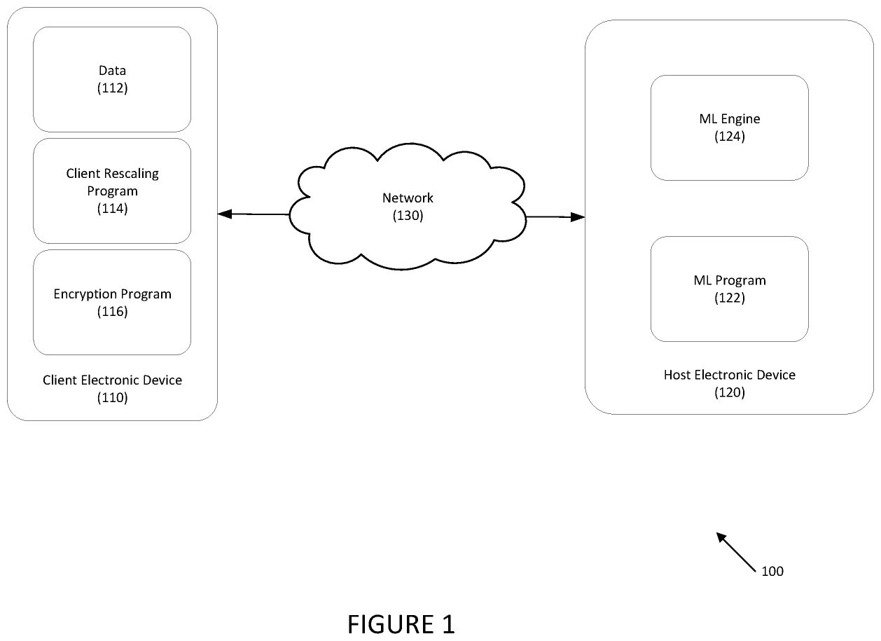

Referring to FIG. 1, a system for mixed precision machine learning with fully homomorphic encryption is provided according to an embodiment. System 100 may include one or more client electronic devices 110 that may execute programs or applications (not shown) that produce data 112. Data 112 may be mixed precision numeric data, such as floating-point numbers.

Client electronic device 110 may execute client rescaling application 114, which may be a computer program or application that converts data 112 to a different format, such as an integer format, and back. For example, client rescaling application 114 may convert data from a mixed precision format to an INT8 format, which is an 8-bit signed integer format. Other formats may be used as is necessary and/or desired.

Encryption computer program 116, or any other suitable program or application, may encrypt the rescaled data to a format that is compatible with fully homomorphic encryption, and may decrypt incoming data from host electronic device 120.

System 100 may further include host electronic device 120 that may execute machine learning (ML) program 122. Host electronic device 120 may be a server (e.g., a physical server, a cloud-based server, combinations thereof, etc.) or any other suitable electronic device. In general, host electronic device 120 may be a more computationally powerful device than client device(s) 110 so that it may perform machine learning.

Client electronic device 110 and host electronic device 120 may communicate over network 130, which may be any suitable communication network.

Machine learning (ML) program 122 may be any suitable program or application that provides data to train ML engine 124, or as an input to ML engine 124, which provides an output. In one embodiment, ML program 122 may be configured to receive encrypted rescaled data from client electronic device 110, process the encrypted rescaled data, and return an encrypted result to client electronic device 110.

Host electronic device 120 and client electronic device 110 may be different types of platforms. For example, host electronic device 120 may be a cloud-based device, and client electronic device 110 may be a mobile electronic device, such as a tablet computer, smart phone, etc. In embodiment, host electronic device 120 may be in an unsecured or untrusted environment in which data from client electronic device 110 could be compromised if decrypted.

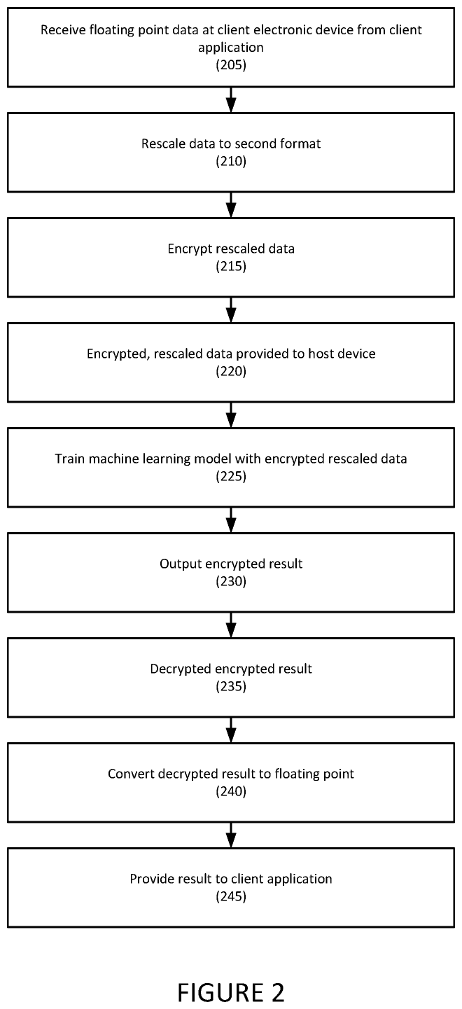

Referring to FIG. 2, a method for mixed precision machine learning with fully homomorphic encryption is provided according to an embodiment.

In step 205, a client rescaling computer program executed by the client electronic device may receive data from a program or application executed by the client electronic device. In one embodiment, the data may be in a first format, such as a floating-point format.

In step 210, a client rescaling computer program executed by the client electronic device may convert the data from the first format to a second format. For example, the client rescaling computer program may convert the data from a floating-point format to an integer format, such as INT8. Any other suitable format may be used as is necessary and/or desired.

In step 215, a client encryption computer program executed by the client electronic device may encrypt the rescaled data. In one embodiment, the client encryption computer program may apply any suitable encryption scheme that is compatible with fully homomorphic encryption.

In step 220, the encrypted, rescaled data may be provided to a host electronic device, such as a server (physical and/or cloud based).

In step 225, the host electronic device may process the encrypted, rescaled data. For example, the host electronic device may use the encrypted, rescaled data to a trained machine learning engine, and in step 230, the host electronic device may provide an encrypted output.

In step 235, the client encryption computer program executed by the client electronic device may decrypt the encrypted result. In one embodiment, the client encryption computer program may apply the same encryption scheme that was used to encrypt the rescaled data.

In step 240, the client rescaling computer program executed by the client electronic device may convert the decrypted result to the first format, such as to a floating-point format.

In step 245, the result may be provided to the client application that provided the data.

Embodiments may provide at least some of the following technical advantages: (1) lower precision/fixed point machine learning may deliver similar results to standard machine learning but may reduce both space and computational requirements; (2) mixed precision machine learning may improve model performance while reducing storage requirements; (3) lower precision requirements may speed up fully homomorphic encryption based inference up to 10 times faster without loss of performance; (4) there is a lower power demand due to smaller computational burden on the edge devices.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for mixed precision machine learning with fully homomorphic encryption, comprising:
receiving, by a client rescaling computer program executed by a client electronic device, data in a mixed precision format from a program or an application executed by the client electronic device;
converting, by the client rescaling computer program, the data from the mixed precision format to an integer format;
encrypting, by a client encryption computer program executed by the client electronic device, the data in the integer format using a fully homomorphic data encryption scheme;
communicating, by the client electronic device, the encrypted data in the integer format to a host electronic device, wherein the host electronic device is configured to process the encrypted data in the integer format and provide an encrypted result in the integer format to the client electronic device;
decrypting, by the client encryption computer program, the encrypted result in the integer format using the fully homomorphic data encryption scheme;
converting, by the client rescaling computer program, the decrypted result in the integer format to the mixed precision format; and
outputting, by the client rescaling computer program, the result in the mixed precision format to the program or the application.

2. The method of claim 1, wherein the mixed precision format is a floating-point format.

3. The method of claim 1, wherein the integer format is an INT8 format.

4. The method of claim 1, wherein the host electronic device is configured to train a machine learning engine using the encrypted data in the integer format.

5. The method of claim 1, wherein the host electronic device is configured to provide a machine learning engine with the encrypted data in the integer format as an input, and the encrypted result comprises an output of the machine learning engine.

6. An electronic device, comprising:
a memory storing a client rescaling computer program and a client encryption computer program; and
a computer processor;
wherein, when executed by the computer processor, the client rescaling computer program or the client encryption computer program cause the computer processor to:
receive data in a mixed precision format from a program or an application executed by the client electronic device;
convert the data from the mixed precision format to an integer format;
encrypt the data in the integer format using a fully homomorphic data encryption scheme;
communicate the encrypted data in the integer format to a host electronic device, wherein the host electronic device is configured to process the encrypted data in the integer format and provide an encrypted result in the integer format to the client electronic device;
decrypt the encrypted result in the integer format using the fully homomorphic data encryption scheme;
convert the decrypted result in the integer format to the mixed precision format; and
output the result in the mixed precision format to the program or the application.

7. The electronic device of claim 6, wherein the mixed precision format is a floating-point format.

8. The electronic device of claim 6, wherein the integer format is an INT8 format.

9. The electronic device of claim 6, wherein the host electronic device is configured to train a machine learning engine using the encrypted data in the integer format.

10. The electronic device of claim 6, wherein the host electronic device is configured to provide a machine learning engine with the encrypted data in the integer format as an input, and the encrypted result comprises an output of the machine learning engine.

11. A system comprising:
a client electronic device executing a client rescaling computer program that receives data in a mixed precision format from a program or an application executed by the client electronic device and converts the data from the mixed precision format to an integer format, and a client encryption computer program that encrypts the data in the integer format using a fully homomorphic data encryption scheme and communicates the encrypted data in the integer format to a host electronic device; and
a host electronic device that processes the encrypted data in the integer format and provides an encrypted result in the integer format to the client electronic device;
wherein the client encryption computer program decrypts the encrypted result in the integer format using the fully homomorphic data encryption scheme, and the client rescaling computer program convert the decrypted result in the integer format to the mixed precision format and outputs the result in the mixed precision format to the program or the application.

12. The system of claim 11, wherein the mixed precision format is a floating-point format.

13. The system of claim 11, wherein the integer format is an INT8 format.

14. The system of claim 11, wherein the host electronic device comprises a machine learning engine trained using the encrypted data in the integer format.

15. The system of claim 11, wherein the host electronic device comprises a machine learning engine, and the host electronic device provides the encrypted data in the integer format as an input to the machine learning engine, and the encrypted result comprises an output of the machine learning engine.
